(19) United States
(12) Patent Application Publication
(10) Pub. No.: US 2006/0281056 A1
(43) Pub. Date: Dec. 14, 2006

(54) System administrator training system and method

(75) Inventors: Steven J. Ouderkirk, West Richland, WA (US); Wayne D. Meitzler, Richland, WA (US)

Correspondence Address: BATTELLE MEMORIAL INSTITUTE, ONE INDIANA SQUARE, SUITE 2800, INDIANAPOLIS, IN, 46204-2079, US

(73) Assignee: Battelle Memorial Institute

(21) Appl. No.: 11/150,396

(22) Filed: Jun. 9, 2005

(51) Int. Cl. G09B 19/00

(52) U.S. Cl. 434/118

(57) ABSTRACT

A computer system and method is disclosed that aids in training system administrators. Users can access the system administrator tool over a secure network, and through the system administrator tool can initiate various offensive and defensive operations against training computers on an isolated network. The system allows one or more users to remotely administer real applications and operating systems on the isolated training network to acquire experience and skills to secure a network from attack. Multiple users, such as a student and an instructor, can establish a communication link to communicate with each other during the simulated attack and defense of the test network.

### BACKGROUND OF THE INVENTION

The present invention relates to computer systems, and more particularly, but not exclusively, relates to systems for training system administrators.

The commercial market offers a broad range of security training for computer and network administrators. Such training typically involves classroom instruction and in a few cases laboratory exercises to provide some hands-on experience. The training allows for quick delivery of security information to students, but it does not provide the in-depth experience that is necessary to manage real-world, real-time events in the workplace.

Many organizations have system administrators located at multiple geographic locations. Sending them to training is costly, and they still will not gain substantial real world experience. One option to providing experience more rapidly is to have system administrators experiment on their own systems or an isolated network in their location. Creating and maintaining an isolated network with extensive attack and defensive tools solely for training purposes is costly. Another option is to allow system administrators to experiment on their production systems; however, this approach runs a risk of damaging production systems, adversely impacting networks, hosts, servers, or routers; or even promulgating attacks widely across the Internet. Therefore, further contributions are needed in this technological arena.

### SUMMARY OF THE INVENTION

One embodiment of the present application is a unique computer system. Other embodiments include unique systems, methods, apparatus, and devices to provide computer training. Further forms, embodiments, objects, advantages, benefits, features, and aspects of the present invention will become apparent from the detailed description and drawings contained herein.

### BRIEF DESCRIPTION OF THE DRAWINGS

FIG. 1 is a diagrammatic view of a computer system of one embodiment of the present invention.

FIG. 2 is a diagrammatic view of a security tool of one embodiment of the present invention.

FIG. 3 is a process flow diagram for the system of FIG. 1 demonstrating the high level stages involved in using the system administrator tool to train system administrators.

FIG. 4 is a process flow diagram for the system of FIG. 1 demonstrating the stages involved in viewing and managing administrative options with the system administrator tool.

FIG. 5 is a process flow diagram for the system of FIG. 1 demonstrating the stages involved in managing users with the system administrator tool.

FIG. 6 is a process flow diagram for the system of FIG. 1 demonstrating the stages involved in managing offensive attacks with the system administrator tool.

FIG. 7 is a process flow diagram for the system of FIG. 1 demonstrating the stages involved in managing defensive operations with the system administrator tool.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

In one embodiment of the present application, a system and/or method are disclosed that aid in training computer network administrators. Users can access the system administrator tool over a secure network, and through the system administrator tool the user can initiate various offensive and defensive operations against training computers on an isolated network. Training computers can be provided as separate hardware platforms, as virtual machines hosted on just one hardware platform or hosted on multiple hardware platforms that number fewer than the quantity of virtually defined training computers, or a combination of these approaches. In one form, user access is provided through a stand-alone program; however, such access could be provided through a web browser or a different interface in alternative embodiments. The system allows one or more users to remotely administer real applications and operating systems on the isolated training network to gain experience and skills in securing a network from attack. Multiple users, such as a student and an instructor, can establish a communication link to communicate with each other during the simulated attack and defense of the test network.

In another embodiment, a computer system and/or method provide a user with secure access to a training environment. Several client computers are coupled together over a network, and are able to communicate with a system administrator tool residing on a server computer. The server computer is also coupled to one or more training computers over an isolated network. From one or more of the client computers, users can access the system administrator tool on the server computer to initiate offensive attacks and defensive operations against the training computers. A firewall is located between the client computers and the server computer to allow the training computers to be accessible only from the server computer. A firewall is also located between the server computer and the training computers to allow one or more security tools residing on one or more of the training computers to only operate against the training computers.

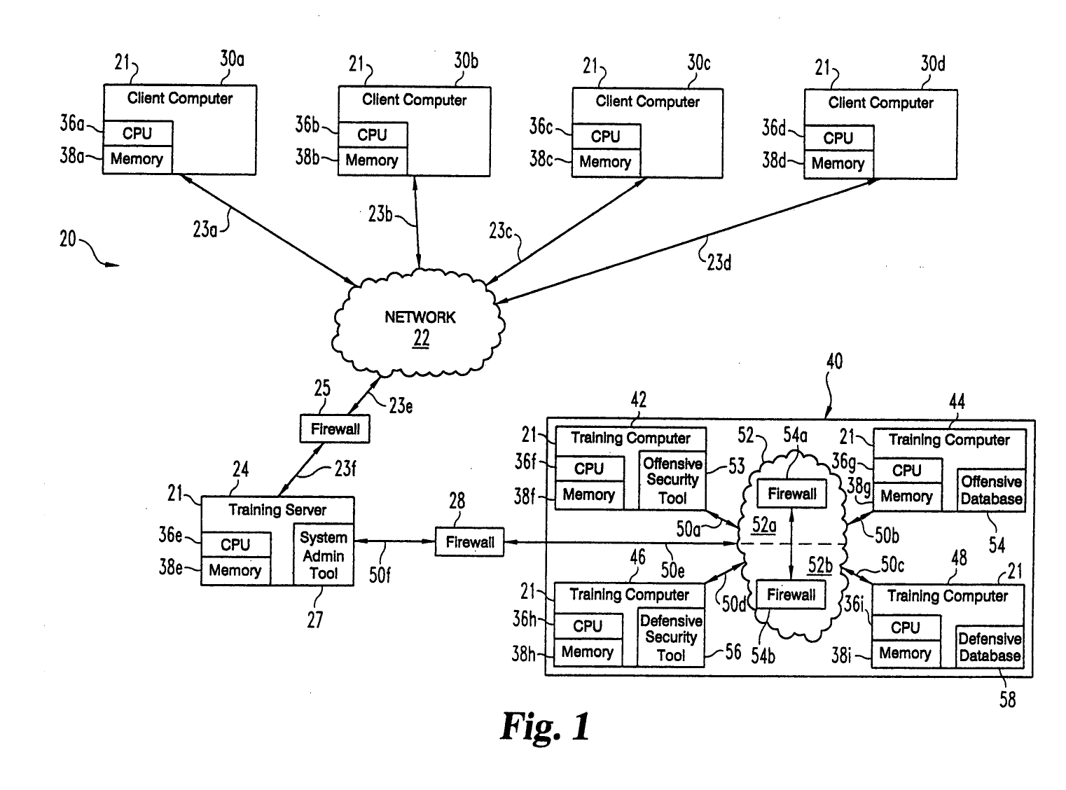

FIG. 1 is a diagrammatic view of computer system 20 of one embodiment of the present invention. Computer system 20 includes computer network 22 and isolated computer network subsystem 40 coupled together by training server 24. Computer network 22 couples together a number of computers 21 (24 and 30a-30d) over network pathways 23a-f. Isolated network subsystem 40 includes network 52 that couples together a number of computers 21 (42, 44, 46, and 48) over network pathways 50a-50f. System 20 includes a server, namely training server 24. System 20 also includes client computers 30a, 30b, 30c, and 30d (collectively 30), and training computers 42, 44, 46, and 48. Firewall 25 is located between network 22 and training server 24, and firewall 28 is located between network 52 and training server 24. While computers 21 are each illustrated as being a server or client, it should be understood that any of computers 21 may be arranged to include both a client and server. Furthermore, it should be understood that while nine computers 21 are illustrated, more or fewer may be utilized in alternative embodiments.

Computers 21 include one or more processors or CPUs (36a, 36b, 36c, 36d, 36e, 36f, 36g, 36h, and 36i, respectively) and one or more types of memory (38a, 38b, 38c, 38d, 38e, 38f, 38g, 38h, and 38i, respectively). Although not shown to preserve clarity, each memory 38a, 38b, 38c, 38d, 38e, 38f, 38g, 38h, and 38i includes a removable memory device. Each processor may be comprised of one or more components configured as a single unit. When of a multi-component form, a processor may have one or more components located remotely relative to the others. One or more components of each processor may be of the electronic variety defining digital circuitry, analog circuitry, or both. In one embodiment, each processor is of a conventional, integrated circuit microprocessor arrangement, such as one or more PENTIUM processors manufactured by INTEL Corporation, having a business address of 2200 Mission College Boulevard, Santa Clara, Calif. 95052, USA.

Each memory (removable or generic) is one form of computer-readable device. Each memory may include one or more types of solid-state electronic memory, magnetic memory, or optical memory, just to name a few. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM); an optical disc memory (such as a DVD or CD ROM); a magnetically encoded hard disc, floppy disc, tape, or cartridge media; or a combination of any of these memory types. Also, each memory may be volatile, nonvolatile, or a hybrid combination of volatile and nonvolatile varieties.

Although not shown to preserve clarity, in one embodiment each computer 21 is coupled to a display. Computers may be of the same type, or a heterogeneous combination of different computing devices. Likewise, displays may be of the same type, or a heterogeneous combination of different visual devices. Although again not shown to preserve clarity, each computer 21 may also include one or more operator input devices such as a keyboard, mouse, track ball, light pen, and/or microtelecommunicator, to name just a few representative examples. Also, besides a display, one or more other output devices may be included such as loudspeaker(s) and/or a printer. Various display and input device arrangements are possible.

Computer network 22 and/or computer network 52 can be in the form of a Local Area Network (LAN), Municipal Area Network (MAN), Wide Area Network (WAN), a combination of these, or such other network arrangement as would occur to those skilled in the art. In one form, network 22 is of a WAN type including the internet. Alternatively or additionally, network 52 is physically a smaller type; however, isolated network subsystem 40 can be structured to host a virtual form of network 52 that operationally behaves as though it has many more networked computers than the nonvirtual quantity actually participating. The operating logic of system 20 can be embodied in signals transmitted over network 22 and/or network 52, in programming instructions, dedicated hardware, or a combination of these. It should be understood that more or fewer computers 21 can be coupled together by computer network 22 and/or network 52.

In one embodiment, system 20 operates at one or more physical locations to provide a system administrator training tool that offers hands-on experience in a controlled environment. In one embodiment, training computer 42 is configured to provide an offensive security tool 53, and training computer 44 is configured to provide a database 54 to store information used by the offensive security tool 53. In one embodiment, training computer 46 is configured to provide a defensive security tool 56, and training computer 58 is configured to provide a database 58 to store information used by the defensive security tool 56. In one embodiment, training server 24 is configured as a training server that hosts system administrator tool 27, and allows system administrator tool 27 to initiate security operations with security tools 53 and/or 56. In one form, client computers 30a-30d interface with server 24 and/or isolated network 40 through a dedicated stand-alone client application. In other forms, client computers 30a-30d can be configured to provide a browser-based user interface to server 24 and/or network 40. At least one of client computers 30a-30d is used for end users to access system administrator tool 27, such as to initiate a security operation against one or more of training computers 42, 44, 46, and 48 using security tools 53 and/or 56. In one embodiment, offensive security tool 53 and defensive security tool 56 are only accessible from training server 24 because of firewall 25. Alternatively or additionally, offensive security tool 53 and defensive security tool 58 can only be used against one or more training computers 42, 44, 46, and 48 on isolated network subsystem 40 because of firewall 28.

Typical applications of system 20 would include more or fewer client computers of this type at one or more physical locations, but four have been illustrated in FIG. 1 to preserve clarity. Furthermore, although one server is shown, it will be appreciated by those of ordinary skill in the art that the one or more features provided by training server 24 could be provided on the same computer or varying other arrangements of computers at one or more physical locations and still be within the spirit of the invention. Farms and/or clusters of dedicated servers could also be provided to support the specific features if desired, using standard techniques known to those skilled in the art.

In still other embodiments, at least some of the training computers are implemented in a virtual form as defined by one or more hosts. For example, multiple training computers can be provided as multiple instances of an operating system hosted on a single processor or platform through VMWare. This implementation of multiple training computers can be used to provide a larger network than would otherwise be possible if limited to available hardware. Furthermore, virtual machine forms of training computers can be mixed with multiple occurrences of actual training computer hardware in still other implementations.

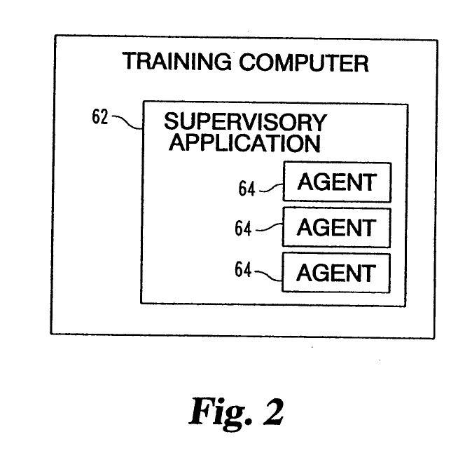

Referring additionally to FIG. 2, each training computer includes supervisory application 62 with one or more agents 64. Each agent 64 encapsulates one or more offensive and/or defensive tools. The supervisory application 62 allows a user to control one or more offensive and/or defensive tools through the agents, either manually or through a predefined attack scenario.

As illustrated, network subsystem 52 is partitioned into two subnetworks 52a and 52b that are separated by routers and/or firewall equipment 54a and 54b, respectively. Subnetwork 52a is utilized to serve as a host for offensive security operations and tools via equipment 54a, and subnetwork 52b is utilized to serve as a host for defensive security operations and tools via equipment 54b. In other embodiments, security tools 53 and/or 56 may be local or distributed to operate on any system in isolated network subsystem 40 that runs the tool. Training tools provided with system 20 can include discovery tools, attack tools, exploitation tools, root-kits, viruses, worms, Trojan horses, and the like. One of ordinary skill in the computer software art will appreciate that various other security tool structures and architectures can be utilized in the alternative.

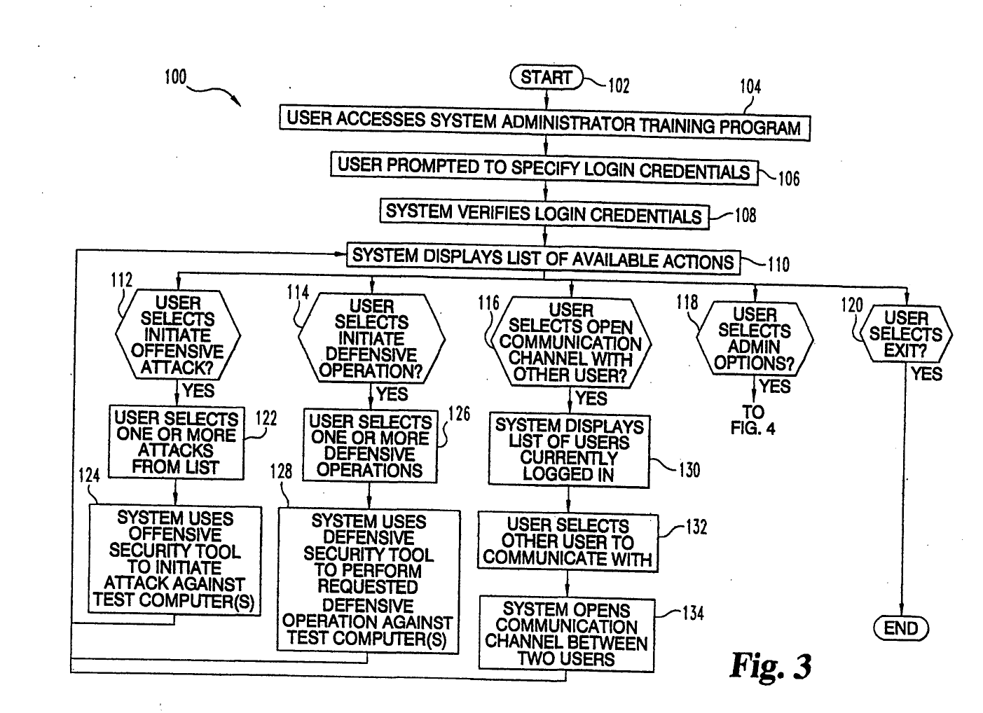

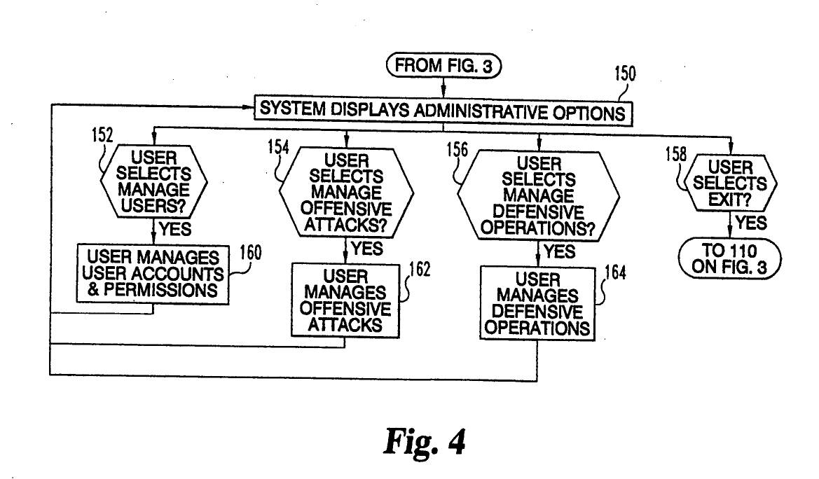

Referring additionally to FIGS. 3 and 4, one embodiment for implementation with system 20 is illustrated in flow chart form as procedure 100, which demonstrates the high level stages involved in using system 20 to train system administrators. In one form, procedure 100 is at least partially implemented in the operating logic of system 20. Procedure 100 begins at start point 102 with the user accessing system administrator training tool 27 from one of client computers 30a, 30b, 30c, or 30d (stage 104). The user is prompted to specify his login credentials (stage 106) and the system verifies that the user is authorized to access the training tool 27 (stage 108). Assuming the user is authorized, the system displays a list of available actions (stage 110) to the user. In one embodiment, the options a user can select include: initiate an offensive attack (112), initiate a defensive operation (114), open a communication channel with another user (116), access administrative options (118) if the user has sufficient authorization, and exit training tool 27 (stage 120).

If the user selects the initiate offensive attack option (decision point 112), then the user selects one or more attacks from a list of available attacks (stage 122). The system then communicates with offensive security tool 53 on training computer 42 to initiate the attack against one or more of training computers 42, 44, 46, and 48 (stage 124). The client/server architecture facilitates distribution and designated control of multiple attack tools and scripts across a heterogeneous network. This approach allows a single operator to simulate coordinated attacks from multiple sources, “low” and “slow” attacks, source masked attacks, or the like.

If the user selects the option to initiate a defensive operation (decision point 114), then the user selects one or more defensive operations from a list of available defensive operations (stage 126). The system then communicates with defensive security tool 56 on training computer 46 to initiate the defensive operation against one or more of training computers 42, 44, 46, and 48 (stage 128).

If the user selects the option to open a communication channel with another user (decision point 116), then the system displays a list of other users currently logged in to training tool 27 (stage 130). The user selects the other user to communicate with (stage 132), and the system opens a communication channel between the two users (stage 134). The communication channel can be one of various types of communications, such as a point to point connection between two computers, or an instant messaging session between the two users, to name a few non-limiting examples. In one embodiment, the communication channel option is used by an instructor and one or more of his students to communicate with each other during one or more offensive and/or defensive security operations.

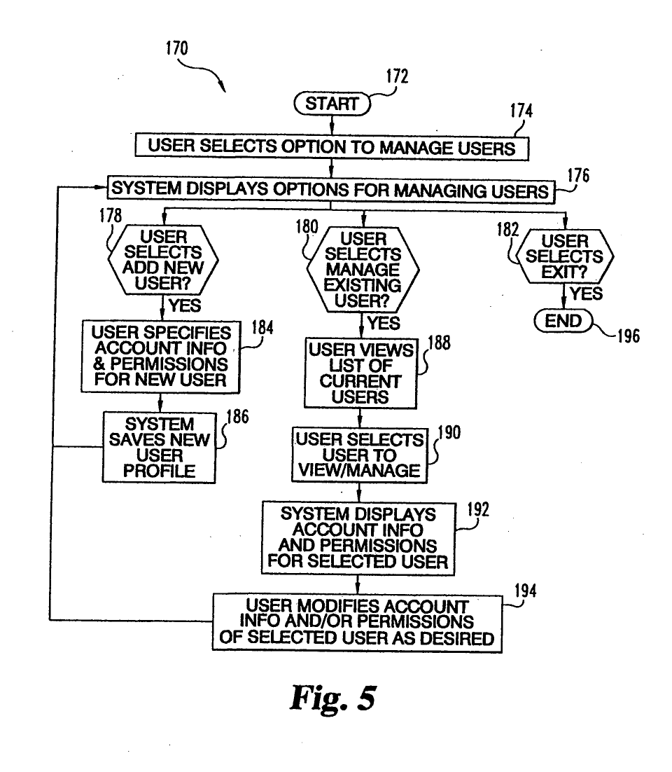

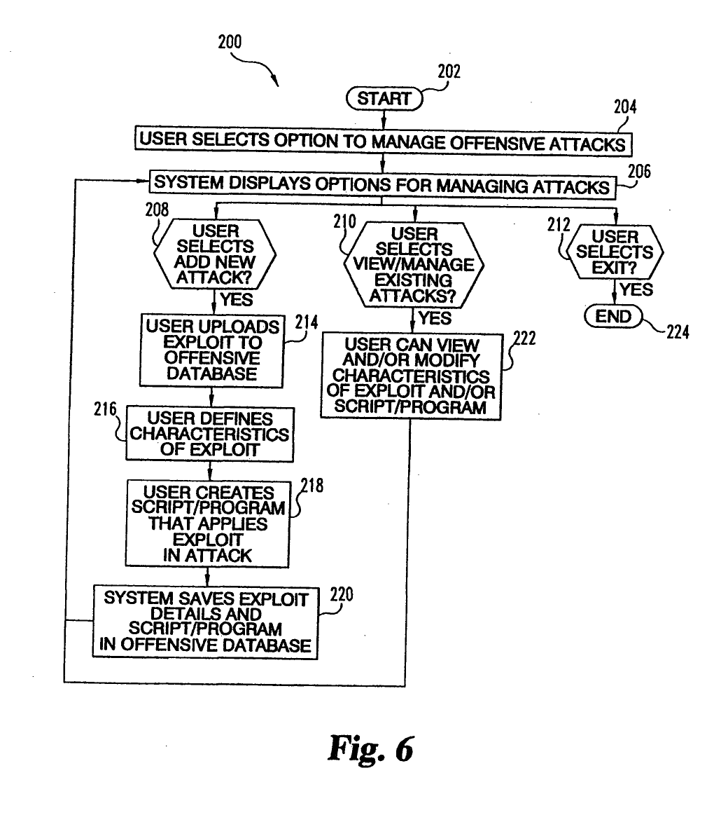

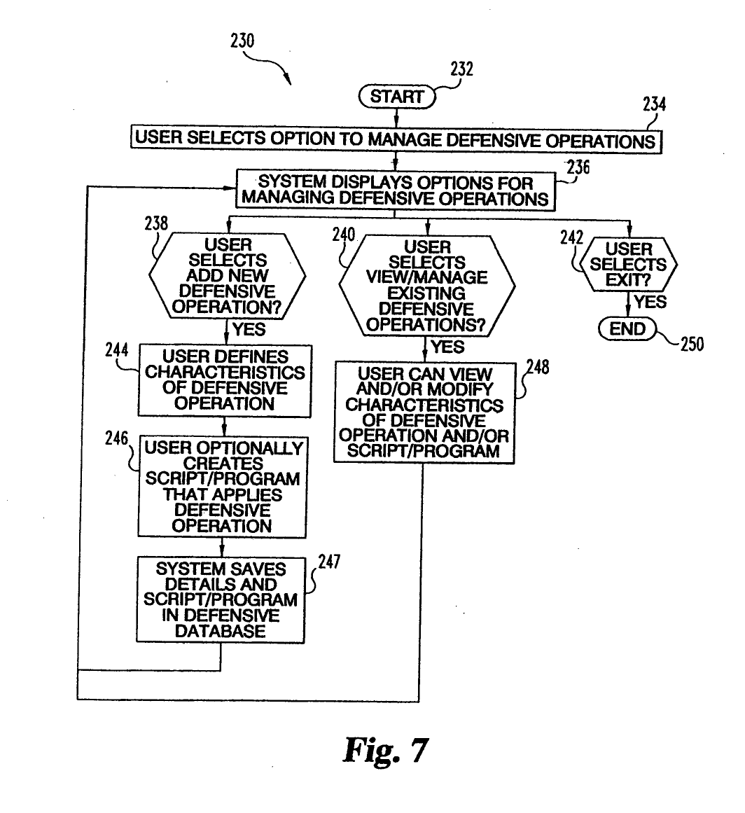

When the user selects the administrative options option (decision point 118), then the system displays the administrative options to the user (stage 150 on FIG. 4). The administrative options module allows the user to manage users (152), manage offensive attacks (154), manage defensive operations (156), and exit the administrative options module (158). In one embodiment, only certain users, such as administrators of the system administrator tool 27, can access the administrative options module. When the user selects the option to manage users (decision point 152), the user can manage user accounts and permissions (stage 160), as described in further detail in FIG. 5. When the user selects the option to manage offensive attacks (decision point 154), the user can manage offensive attacks (stage 162), as described in further detail in FIG. 6. When the user selects the option to manage defensive operations (decision point 156), the user can manage defensive operations (stage 164), as described in further detail in FIG. 7.

Returning now to FIG. 3, when the user selects the Exit option (decision point 120), the user is exited out of system administrator tool 27. Procedure 100 then ends at stage 136.

Turning now to FIG. 5, procedure 170 demonstrates the stages involved in managing users with system administrator tool 27. In one form, procedure 170 is at least partially implemented in the operating logic of system 20. Procedure 170 begins at start point 172 with the user selecting an option to manage users (stage 174). The system then displays the options that the user can select for managing users (stage 176). The options include adding a new user (178), managing existing users (180), and exiting (stage 182) the user management module. If the user selects the add new user option (decision point 178), then the user can specify the account information and permissions for the new user (stage 184). A few non-limiting examples of account information include name, user id, and password. A few non-limiting examples of permissions include which modules in system administrator tool 27 the user has access to, and which attacks and/or defensive operations the user has access to.

If the user selects the manage existing user option (decision point 180), then the user can view a list of current users (stage 188), and selects a particular user to view and/or manage (stage 190). Upon selection of a particular user (stage 190), the system displays the account information and permissions for the selected user (stage 192). The user can then modify the account information and/or the permissions for the selected user as desired (stage 194). If the user selects the option to exit, then procedure 170 ends at end point 196.

Turning now to FIG. 6, procedure 202 demonstrates the stages involved in managing offensive attacks with system administrator tool 27. In one form, procedure 202 is at least partially implemented in the operating logic of system 20. Procedure 202 begins at start point 204 with the user selecting an option to manage offensive attacks (stage 204). The system then displays the options that the user can select for managing offensive attacks (stage 206). The options include adding new attacks (208), viewing/managing existing attacks (210), and exiting (212) the attack management module. If the user selects the option to add a new attack (decision point 208), then the user uploads the exploit to the offensive database 54 (stage 214) and specifies the characteristics of the exploit (stage 216). The user creates a script/program that applies the exploit in a attack (stage 218) against one or more of training computers 42, 44, 46, and 48. The system saves the details about the exploit and the script/program in offensive database 54 (stage 247). An exploit is first added to the database through an offensive database management tool. The offensive tool is then available to be added to an attack script that may be created programmatically or recorded through a scripting tool. Once an attack script is created it is named and added to a list of saved scripts. The attacker can then select from the list of saved scripts to launch attacks against target systems. If the user selects the option to view and manage existing attacks (decision point 210), then the user can view and/or modify the characteristics of the existing attacks and/or the associated script/program (stage 222). If the user selects the Exit option (decision point 212), then the process ends at stage 224.

Turning now to FIG. 7, procedure 230 demonstrates the stages involved in managing defensive operations with system administrator tool 27. In one form, procedure 230 is at least partially implemented in the operating logic of system 20. Procedure 230 begins at start point 232 with the user selecting an option to manage defensive operations (stage 234). The system then displays the options that the user can select for managing defensive operations (stage 236). The options include adding new defensive operation (238), viewing/managing existing defensive operations (240), and exiting (242) the defensive operation management module. If the user selects the option to add new defensive operation (decision point 238), then the user specifies the characteristics of the defensive operation (stage 244). The user can optionally create a script/program that applies the defensive operation (stage 246) to one or more of training computers 42, 44, 46, and 48. The system saves the details about the defensive operation and the script/program in defensive database 58 (stage 247). A defensive operation is first added to the database through a defensive database management tool. The defensive tool is then available to be added to a script that may be created programmatically or recorded through a scripting tool. Once a script is created it is named and added to a list of saved scripts. The attacker can then select from the list of saved scripts to launch attacks against target systems. If the user selects the option to view and manage existing defensive operations (decision point 240), then the user can view and/or modify the characteristics of the existing defensive operations and/or the associated script/program (stage 248). If the user selects the Exit option (decision point 242), then the process ends at stage 250.

Many variations and different embodiments of the present application are envisioned. For example, in one embodiment, a system is disclosed that comprises a plurality of training computers and at least one security tool that is capable of performing a security operation against one or more of the training computers. A server computer is coupled to the plurality of training computers over a first network. A first firewall is located between the plurality of training computers and the server computer. At least one client computer is coupled to the server computer over a second network. A second firewall is located between the at least one client computer and the server computer. The server computer hosts a system administrator training program that allows the at least one client computer to request an initiation of a security operation on one or more of the training computers using the at least one security tool.

In another embodiment, a system is disclosed that comprises a plurality of training computers and a server computer. The system also includes a means for coupling the server computer to the training computers and a means for allowing the training computers to be accessible only from the server computer. The system also has at least one client computer, and a means for coupling the client computer to the server computer. The system also has a means for allowing the server computer to be accessible only from the at least one client computer. The system includes an offensive attack means for allowing the at least one client computer to request an initiation of an offensive attack against one or more of the training computers, as well as a defensive means for allowing the at least one client computer to request a defensive operation against an attack taking place on one or more of the training computers.

In yet a further embodiment, an apparatus is disclosed that comprises a device encoded with logic executable by one or more processors to provide a system administrator training program that is operable to: receive a request from a first client computer to access the training program; verify that the first client computer is authorized to access the training program; receive a request from a second client computer to access the training program; verify that the second client computer is authorized to access the training program; upon request from the first client computer, initiate an offensive attack against one or more of a plurality of training computers on a secure network; and upon request from the second client computer, initiate a defensive operation against the attack taking place against the one or more training computers.

In another embodiment, a method is disclosed that comprises receiving a request from a first client computer to access a system administrator training program hosted on a server accessible over a first network. The first client computer is verified to have authorization to access the system administrator training program. A request is received from a second client computer to access the system administrator training program. The second client computer is verified to have authorization to access the system administrator training program. Upon request from the first client computer, an offensive attack is initiated against one or more of a plurality of training computers, said training computers being coupled together over a second network. Upon request from the second client computer, a defensive operation is initiated against the attack taking place against the one or more training computers.

A further embodiment includes a method, system, and/or encoded logic to provide a computer network training arrangement. This training arrangement includes a training program to perform offensive computer attacks and defensive operations on an isolated computer network, remotely through a firewall-connected server and/or locally relative to the isolated network. The isolated network includes a first subnetwork that is utilized for offensive computer attacks or intrusions and a second subnetwork that is utilized for defensive, protective computer operations. The first and second subnetworks are separated from one another within the isolated network by equipment including a firewall and/or router. In one form, remote access to the isolated network is provided to one or more computer security trainers and one or more students, and/or the offensive and defensive tools are each hosted on a different server of the corresponding first or second subnetwork.

Still a further embodiment involves a method that includes: hosting a system administrator training program on a server coupled to a first client and a second client over a first computer network; in response to the first client, executing an offensive attack against an implementation of several training computers coupled together over a second network; and in response to the second client, executing a defensive operation in response to the offensive attack. Still other embodiments include a device carrying operating logic that can be executed with a computer to perform this method and a system structure to perform this method. The implementation can provide any of the training computers as virtual machines defined by one or more hosts, and/or the implementation includes a plurality of hardware platforms each corresponding to one of the training computers.

Another embodiment includes: means for hosting a system administrator training program on a server coupled to a first client and a second client over a first computer network; means for executing an offensive attack against an implementation of several training computers coupled together over a second network; and means for executing a defensive operation in response to the offensive attack. The implementation can provide any of the training computers as virtual machines defined by one or more hosts, and/or the implementation includes a plurality of hardware platforms each corresponding to one of the training computers.

While the invention has been illustrated and described in detail in the drawings and foregoing description, the same is to be considered as illustrative and not restrictive in character, it being understood that only selected embodiments have been set forth herein, and that all equivalents, changes, and modifications of the inventions as described herein and/or defined by the following claims are desired to be protected.

What is claimed is:

1. A system comprising:
a plurality of training computers;
at least one security tool operable to perform a security operation relative to one or more of the training computers;
a server computer, said server computer being coupled to the plurality of training computers over a first network;
a first firewall located between the plurality of training computers and the server computer;
at least one client computer, said client computer being coupled to the server computer over a second network;
a second firewall located between the at least one client computer and the server computer; and
wherein said server computer hosts a system administrator training program, said training program being operable to allow the at least one client computer to request initiation of a security operation on one or more of the training computers using the at least one security tool.

2. The system of claim 1, wherein the first network is a local area network and wherein the second network is the Internet.

3. The system of claim 1, wherein the first network is comprised of a first subnetwork to provide offensive computer attacks and a second subnetwork to provide defensive computer security operations.

4. The system of claim 1, further comprising means for accessing the training computers through the server computer and wherein the at least one security tool includes means for only operating offensively in relation to the training computers.

5. The system of claim 1, wherein the first firewall is operable to access the training computers through the server computer, and the second firewall is operable to allow the server computer to be accessible through the at least one client computer after proper login credentials have been provided.

6. The system of claim 1, wherein the at least one security tool is located on one or more of the training computers.

7. The system of claim 1, wherein the training software is operable, upon request from an authorized user of the client computer, to communicate with the security tool to begin an offensive attack against one or more of the training computers.

8. The system of claim 7, wherein the training software is operable to allow the user to define one or more desired attack scenarios.

9. The system of claim 1, wherein the training software is operable, upon request from an authorized user using the client computer, to communicate with the security tool to begin a defensive operation against an attack taking place on one or more of the training computers, thereby providing the user with hands-on experience in defending a real network against a security attack.

10. The system of claim 1, wherein the at least one client computer includes a first client computer and a second client computer, said first client computer being operated by an instructor, said second client computer being operated by a student, wherein the training software communicates with the security tool to initiate an attack against one or more of the training computers upon request from the instructor, and wherein the training software communicates with the security tool to initiate a defensive operation against an attack taking place on one or more of the training computers upon request of the student.

11. The system of claim 10, wherein the first client computer and the second client computer are operable to communicate over a communication link to enable the instructor to provide instructions to the student.

12. The system of claim 1, wherein the security tool includes a supervisory application and one or more agent applications, said agent applications each being operable to simulate a particular type of attack, and said supervisory application being operable to allow a user to control the one or more agent applications.

13. An apparatus comprising: a device encoded with logic executable by one or more processors to:
provide a system administrator training program that is operable to: receive a request from a first client computer to access the training program; verify that the first client computer is authorized to access the training program; receive a request from a second client computer to access the training program; verify that the second client computer is authorized to access the training program; upon request from the first client computer, initiate an offensive attack against one or more of a plurality of training computers on a secure network; and upon request from the second client computer, initiate a defensive operation against the attack taking place against the one or more training computers.

14. The apparatus of claim 13, wherein the device includes a removable memory device carrying a number of processor executable instructions to define the logic.

15. The apparatus of claim 13, wherein the removable memory device includes a disk.

16. A method comprising:
receiving a request from a first client computer to access a system administrator training program hosted on a server accessible over a first network;
verifying that the first client computer is authorized to access the system administrator training program;
receiving a request from a second client computer to access the system administrator training program;
verifying that the second client computer is authorized to access the system administrator training program;
upon request from the first client computer, initiating an offensive attack against one or more of a plurality of training computers, said training computers being coupled together over a second network; and
upon request from the second client computer, initiating a defensive operation against the attack taking place against the one or more training computers.

17. The method of claim 16, wherein the first network is the Internet and the second network is a local area network.

18. The method of claim 16, wherein the first client computer is being operated by an instructor and wherein the second client computer is being operated by a student.

19. The method of claim 16, wherein the first client computer and the second client computer are the same computer.

20. The method of claim 16, which includes partitioning offensive attack tools of one subnetwork of the second network from defensive security tools of another subnetwork of the second network.

21. A method comprising:
hosting a system administrator training program on a server coupled to a first client and a second client over a first computer network;
in response to the first client, executing an offensive attack against an implementation of several training computers coupled together over a second network; and
in response to the second client, executing a defensive operation in response to the offensive attack.

22. The method of claim 21, wherein the first network is the Internet and the second network is a local area network and the first client is being operated by an instructor and the second client is being operated by a student.

23. The method of claim 21, wherein the implementation provides each of two or more of the training computers as virtual machines defined by one or more hosts.

24. The method of claim 21, wherein the implementation includes a plurality of hardware platforms each corresponding to one of the training computers.

25. The method of claim 21, which includes partitioning offensive attack tools from defensive security tools on the second network by defining subnetworks.
